(19) United States
(12) Patent Application Publication
(10) Pub. No.: US 2026/0079522 A1
(43) Pub. Date: Mar. 19, 2026

(54) PEDAL DEVICE FOR A VEHICLE, AND A VEHICLE

(71) Applicant: HELLA GMBH & CO. KGAA, Lippstadt (DE)

(72) Inventors: Kristin Gees, Lippstadt (DE); Gilbert Grunow, Dortmund (DE); Kerim Florian Huge, Lippstadt (DE); Robert Schuermann, Herzebrock-Clarholz (DE); Daniel Suesselbeck, Lippstadt (DE); Henning Ufermann, Soest (DE); Johannes Wolf, Lippstadt (DE)

(21) Appl. No.: 19/326,989

(22) Filed: Sep. 12, 2025

(30) Foreign Application Priority Data
Sep. 13, 2024 (DE) 102024126415.2

(51) Int. Cl. G05G 5/03; B60T 7/04; G05G 1/44

(52) U.S. Cl. CPC G05G 5/03; B60T 7/04; G05G 1/44; G05G 2505/00

(57) ABSTRACT

A pedal device for a vehicle has a housing, a pedal lever which is rotatably mounted in a sliding manner at a bearing point on the housing, an intermediate lever which is coupled to the pedal lever via a first coupling point and to the housing via a second coupling point, and a force-generating unit for exerting a counterforce on the rotatable pedal lever. The counterforce acts in the opposite direction to an actuating force exerted on the rotatable pedal lever. The intermediate lever and the force-generating unit are designed such that when the pedal lever is actuated, a pedal travel/actuating force characteristic with hysteresis is established.

### CROSS-REFERENCE TO RELATED APPLICATIONS

The present application claims the benefit of German Patent Application No. 10-2024-126-415.2, filed Sep. 13, 2024, the disclosure of which is incorporated by reference.

### FIELD OF THE INVENTION

The invention relates to a pedal device for a vehicle, having a housing, a pedal lever which is pivotally mounted in a sliding bearing at a bearing point on the housing, an intermediate lever which is coupled to the pedal lever via a first coupling point and to the housing via a second coupling point, in such a way that when the pedal lever is displaced, the intermediate lever is also displaced, and a force-generating unit for exerting a counterforce on the pivotally mounted pedal lever, the counterforce acting in the opposite direction to an actuating force exerted on the pivotally mounted pedal lever. Furthermore, the present invention relates to a vehicle having such a pedal device.

### BACKGROUND OF THE INVENTION

Such pedal devices are known per se and are used in motor vehicles, in which a braking force exerted by an operator is used for the electric and/or electronic control (brake by wire) of a separate braking system. Brake-by-wire pedals are pedals in which there is no longer a direct operative connection between the pedal on one side and an actuator on the other side, as is the case with a conventional pedal. In a conventional brake pedal, for example, the brake pedal is directly coupled to the brakes by means of a hydraulic system. This direct operative connection is no longer present with a brake-by-wire pedal. Instead, for example, a rotary movement of a pedal lever about an axis of rotation is detected by a sensor, converted into an output signal, and used to control the braking system of the vehicle. In order to reproduce the haptic impressions that exist with a conventional pedal, the pedal devices usually have a force-generating unit that reproduces such an actuating force when the pedal lever is actuated, so that a user of the brake-by-wire pedal is given the impression of a conventional brake pedal, i.e. a brake pedal familiar to him. Such a design of the pedal device is also used in other pedals, for example, clutch pedals.

For example, a pedal device of this kind is disclosed in DE 10-2021-124-879 A1. The pedal device comprises a pedal lever, an intermediate lever, and a force-generating unit. The force-generating unit is designed in such a way that when the pedal lever is actuated, a pedal travel/actuating force diagram with a hysteresis characteristic is present. A hysteresis characteristic is defined here as a different force/travel characteristic when the pedal lever is actuated and when it is released.

### SUMMARY OF THE INVENTION

The object of the invention is to provide a pedal device which, when the pedal lever is actuated, causes a pedal travel/actuating force diagram with a hysteresis characteristic and is designed to be simple, space-saving, and cost-effective.

The object is achieved by the features of the current embodiments. The object is further achieved by a vehicle with such a pedal device.

According one embodiment, the first coupling point and the second coupling point are arranged at a distance from one another in the longitudinal direction of the intermediate lever, and the force-generating unit has a spring element arranged at the second coupling point, wherein the intermediate lever bears against the pedal lever via a third coupling point on the pedal lever or is slidingly mounted on the housing, such that during actuation of the pedal lever the intermediate lever acts on the pedal lever or the housing via the third coupling point in such a loading manner that a pedal travel/actuating force characteristic with hysteresis is produced. At the first coupling point, the intermediate lever can be connected directly or indirectly to the pedal lever. The second coupling point is arranged in the longitudinal direction of the intermediate lever between the first coupling point and the third coupling point.

In a first embodiment, the intermediate lever is supported at the second coupling point on the housing in a rocker-like manner, whereby when the pedal lever is actuated, which in this case pivots about an axis of rotation at the bearing point, the intermediate lever pivots together with the pedal lever about the axis of rotation due to the operative connection to the pedal lever. During the pivoting of the intermediate lever, the spring element arranged at the second coupling point is compressed with increasing spring force, i.e., with an increasing counterforce, whereby a lever action is produced due to the spaced-apart arrangement of the first and the second coupling points. Due to the lever action, the intermediate lever is pressed against the pedal lever, and, thus, the pedal lever is pressed against the bearing surface of the housing at the bearing point or the third coupling point, thereby increasing the frictional force between the housing and the pedal lever. The magnitude of the change in the frictional force when the pedal lever is actuated can be specifically adjusted by the spring rate of the spring element and the lever ratios, i.e., the distances between the first coupling point and the second coupling point, as well as between the second coupling point and the third coupling point.

In a second embodiment, the intermediate lever is supported at the first coupling point on the pedal lever in the manner of a rocker, wherein when the pedal lever is actuated, which in this case pivots about an axis of rotation at the bearing point, the intermediate lever pivots about the axis of rotation together with the pedal lever due to the coupling of the pedal lever to the intermediate lever at the first coupling point. During the pivoting of the intermediate lever, the spring element arranged at the second coupling point is compressed with increasing spring force, i.e., with an increasing counterforce, whereby a lever action is produced due to the spaced-apart arrangement of the first and the second coupling points. By means of the lever action, the intermediate lever is pressed against the corresponding bearing surface of the housing at the third coupling point, and as a result, an increase in the frictional force between the housing and the intermediate lever is caused. The magnitude of the change in the frictional force when the pedal lever is actuated can also in this case be specifically adjusted by the spring rate of the spring element and the lever ratios, i.e., the distances between the coupling points. The first coupling point is arranged in the longitudinal direction of the intermediate lever between the second coupling point and the third coupling point.

According to another embodiment, the force-generating unit has a spring element at the second coupling point, wherein the intermediate lever is slidingly mounted with friction on the housing via a third coupling point by means of a spring element, such that the intermediate lever is loaded by the spring element in such a way that a pedal travel/actuating force characteristic with hysteresis is produced. At the first coupling point, the intermediate lever can be connected directly or indirectly to the pedal lever.

By means of the pivotable mounting of the intermediate lever on the housing via the third coupling point, the operative connection of the intermediate lever to the pedal lever, and the spring element at the second coupling point, the intermediate lever pivots together with the pedal lever when the pedal lever is actuated, whereby the intermediate lever moves via the third coupling point in a sliding friction motion on a bearing surface of the housing relative to the housing. By means of the spring force of the spring element, which presses the intermediate lever against the housing at the third coupling point, the friction or the frictional force acting between the intermediate lever and the housing during the pivoting of the pedal lever and thus of the intermediate lever, is caused. The friction caused by the spring element between the intermediate lever and the housing can be specifically adjusted by the spring rate of the spring element. Furthermore, the intermediate lever may have a friction element at the third coupling point, via which the intermediate lever bears against the housing. By means of the friction element, the coefficient of friction, and thus the friction between the friction element and the housing during pivoting of the intermediate lever, can be adjusted.

In the current embodiments, the frictional force always counteracts the movement, so that when the pedal lever is depressed by the actuating force, the frictional force must also be overcome in addition to the spring force of the spring element arranged at the second coupling point. When the pedal lever is released, whereby the pedal lever and the intermediate lever are moved to the initial state by the spring force of the spring element at the second coupling point, the movement of the pedal lever and the intermediate element is reversed, wherein the frictional force counteracts the spring force of the spring element. This results in a pedal travel/actuating force characteristic with hysteresis. In this case, the actuating force acting on the pedal lever at a certain travel during depression of the pedal lever is greater than during return of the pedal lever.

In this way, a pedal device can be provided which, when the pedal lever is actuated, causes a pedal travel-actuating force diagram with a hysteresis-related curve and which is designed to be simple, space-saving and inexpensive, with no or virtually no additional components being required to provide a hysteresis characteristic when the pedal lever is displaced.

In a preferred configuration of the first embodiment, an additional loading unit is provided, which is arranged in the region of the third coupling point, wherein the additional loading unit has a loading element and a spring element arranged between the housing and the loading element, wherein the loading element bears against the intermediate lever in a sliding-friction and spring-biased manner in such a way that the intermediate lever is loaded in the direction of the pedal lever. Preferably, the loading element is mounted on the housing in a manner of a rocker, wherein the loading element bears with a first end at the bearing point on the intermediate lever and the spring element acts on a second end. This can increase the friction acting at the bearing point between the pedal lever and the housing.

Preferably, the force-generating unit has a first spring element and a second spring element, wherein the first spring element is arranged at the first coupling point and the second spring element is arranged at the second coupling point, wherein the second spring element has a lower spring rate than the first spring element, and wherein the intermediate lever bears against a stop provided on the housing from a predefined spring travel of the second spring element. The two spring elements can provide a non-linear pedal travel/actuating force characteristic when the pedal lever is actuated, which corresponds to the feel of a conventional pedal. The different spring rates result in a pedal travel/actuating force characteristic with two sections with different gradients.

Because the spring rate of the first spring element is higher than the spring rate of the second spring element, the first spring element can be regarded as almost rigid in a first travel section, wherein only the second spring element is compressed and the pedal lever is displaced together with the intermediate lever. As soon as the intermediate lever comes into contact with the stop, a second travel section begins, and only the first spring element is compressed.

In a preferred configuration of the pedal device according to some embodiments, the first spring element and the second spring element are arranged coaxially to one another. As a result, no lever action is intentionally caused on the intermediate lever.

Alternatively, the force-generating unit has a first spring element and a second spring element, wherein both spring elements are arranged at the second coupling point and in series, wherein the second spring element has a lower spring rate than the first spring element, wherein the intermediate lever striking a stop of the housing from a predefined spring travel of the second spring element. By means of the two spring elements, a non-linear pedal travel/actuating force characteristic can also be provided here when the pedal lever is actuated, which corresponds to the feel of a conventional pedal. The different spring rates of the spring elements result in a pedal travel/actuating force characteristic with two sections having different gradients, wherein both spring elements are arranged at the second coupling point to save installation space. The coupling between the pedal lever and the intermediate lever is achieved in particular by the pedal lever bearing directly against the intermediate lever with a projection at the first coupling point.

Preferably, the stop between the intermediate lever and the housing is arranged at a distance from the first coupling point in the longitudinal direction of the intermediate lever. As a result, even when the intermediate lever rests against the stop of the housing, an increase in the load exerted by the intermediate lever at the third coupling point can be caused by means of a lever action, whereby in turn the frictional force between the intermediate lever and the housing or between the pedal lever and the housing can be increased.

Preferably, the pedal lever has a cylindrical bearing surface at the bearing point, by means of which the pedal lever bears locally against several bearing surfaces of the housing, which are spaced apart from one another in the circumferential direction, with a predefined slope. By changing the slope of the bearing surfaces of the housing, the friction between the pedal lever and the housing can be specifically adjusted. Here, the frictional force acting between the friction surfaces increases with the increase in the slope of the friction surfaces of the housing.

Preferably, the force-generating unit has a return spring, by means of which the pedal lever is loaded in the direction of a rest position, i.e., in an unactuated position. In a preferred configuration, the spring element of the additional loading unit or the third spring element is the return spring. This means that the return spring can be used for different functions, allowing the pedal device to be designed in a cost-effective and space-saving manner.

### BRIEF DESCRIPTION OF THE DRAWINGS

The invention is explained in more detail hereafter with reference to the accompanying drawings. In the figures:

FIG. 1 is a first embodiment of the pedal device in a first sectional plane;

FIG. 2 is a second embodiment of the pedal device in a first sectional plane;

FIG. 3 is a third embodiment of the pedal device in a first sectional plane;

FIG. 4 is a section of the pedal device according to FIG. 1, FIG. 2 and FIG. 3 in a second sectional plane; and

FIG. 5 is a pedal travel/actuating force diagram of a pedal device according to FIG. 1, FIG. 2 and FIG. 3.

### DETAILED DESCRIPTION OF THE CURRENT EMBODIMENTS

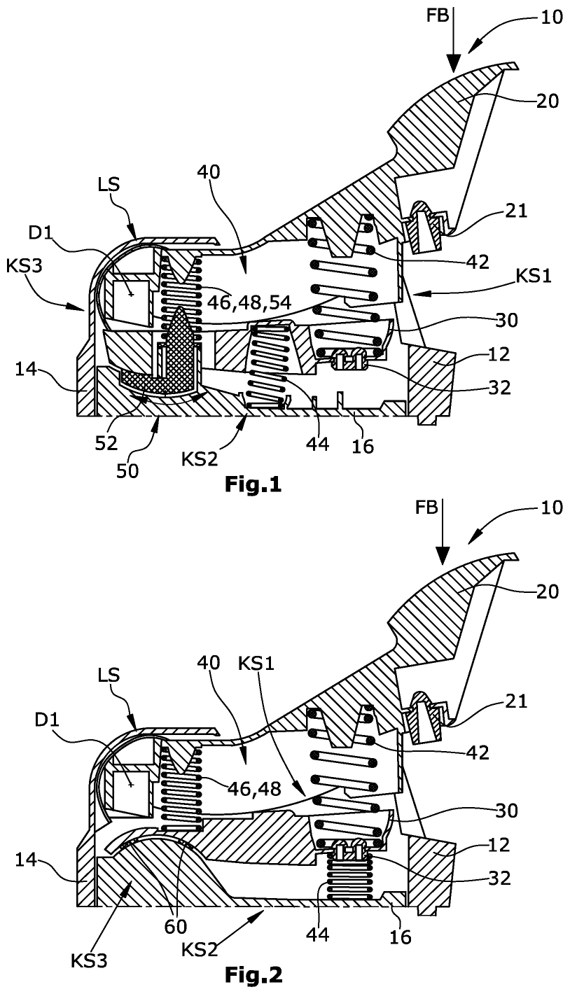

FIG. 1 and FIG. 2 each show a pedal device 10 for a vehicle, which is a brake pedal, for example. The pedal device 10 forms a so-called brake-by-wire pedal, wherein a braking force exerted by a driver is used for the electrical and/or electronic activation (brake by wire) of a separate braking system not shown in the figures. With brake-by-wire pedals, there is no longer a direct operative connection between the pedal on one side and an actuator on the other, as there is with a conventional pedal. Instead, for example, a rotary movement of a pedal lever 20 about an axis of rotation is detected by a sensor, converted into an output signal and used to control a braking system of the vehicle. The pedal devices 10 are designed in such a way that the haptic impressions existing with a conventional pedal are reproduced. In the following explanation, the pedal device 10 is explained by way of example in terms of a brake pedal, wherein the pedal device 10 could also be any other X-by-wire pedal.

The pedal device 10 has a housing 12 with a first housing element 14 and a second housing element 16 connected to the first housing element 14. The housing 12 forms the base component of the pedal device 10, wherein the pedal device 10 is attached to another vehicle component via the housing 12.

The pedal device 10 further comprises a pedal lever 20, an intermediate lever 30, and a force-generating unit 40.

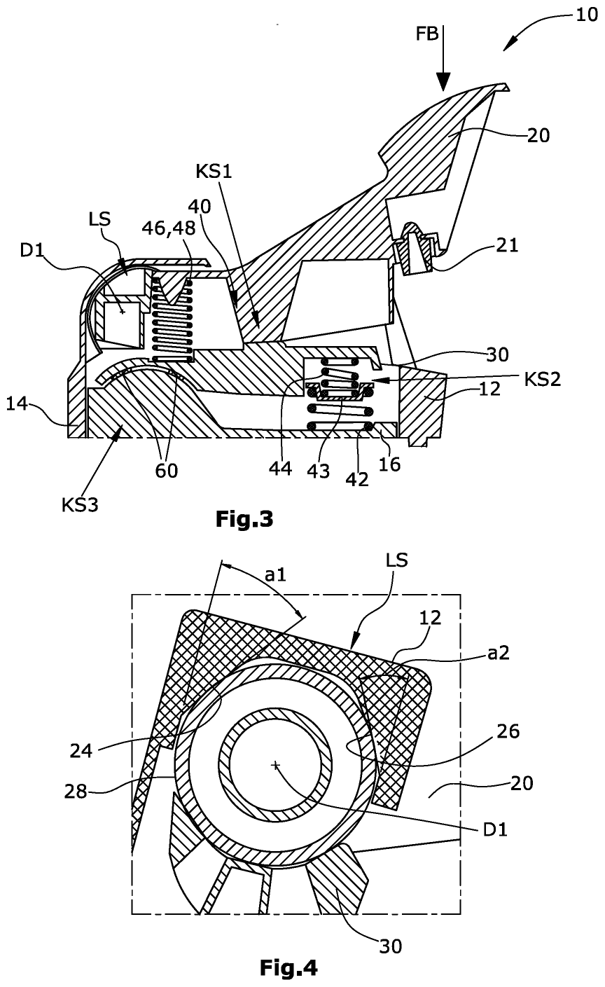

The pedal lever 20 is the component to which a driver can apply an actuating force FB, which would cause the pedal lever 20 to rotate about an axis of rotation D1. The pedal lever 20 is rotatably supported in a sliding manner on the housing 12, the housing 12 having two inclined bearing surfaces 24, 26 at a bearing point LS, against which a cylindrical bearing surface 28 of the pedal lever 20 bears. The bearing point LS is shown in FIG. 3. The bearing surfaces 24, 26 each form an angle a1, a2 with a plane.

The intermediate lever 30 and the force-generating unit 40 serve in particular to reproduce the haptic impressions of a conventional pedal. The intermediate lever 30 is arranged between the pedal lever 20 and the housing 12 or the second housing element 16.

In the first embodiment in FIG. 1, the intermediate lever 30 is coupled to the pedal lever 20 via a first coupling point KS1, to the housing 12 or the second housing element 16 via a second coupling point KS2, and in turn to the pedal lever 20 via a third coupling point KS3, wherein the third coupling point KS3 is arranged at the bearing point at which the pedal lever 20 is mounted on the housing 12, and the intermediate lever 30 bears against the side of the bearing surface 28 of the pedal lever 20 facing away from the bearing surfaces 24, 26. The coupling points KS1, KS2, and KS3 are arranged in such a way that the first coupling point KS1 and the third coupling point KS3 are arranged on a side of the intermediate lever 30 facing the pedal lever 20, and the second coupling point KS2 is arranged on a side of the intermediate lever 30 facing away from the pedal lever 20. In addition, all coupling points KS1, KS2, KS3 are arranged at a distance from one another in the longitudinal direction of the intermediate lever 30.

The force-generating unit 40 has a first spring element 42 and a second spring element 44. The first spring element 42 is arranged at the first coupling point KS1 and is thus arranged between the intermediate lever 30 and the pedal lever 20. The second spring element 44 is arranged at the second coupling point KS2 and is thus arranged between the intermediate lever 30 and the housing 12. The spring rate of the first spring element 42 is greater than the spring rate of the second spring element 44. The force-generating unit 40 also has a third spring element 46, which is arranged between the housing 12 and the pedal lever 20. The third spring element 46 serves as a fail-safe spring or return spring 48, so that in the event of a breakage of the first spring element 42, the second spring element 44, and/or the intermediate lever 30, the pedal lever 20 is displaced by the third spring element 46 into the rest position, i.e., into an unactuated position, thereby reliably preventing an undesired displacement of the pedal lever 20 and thus an undesired brake actuation due to the breakage of the first spring element 42, the second spring element 44, and/or the intermediate lever 30.

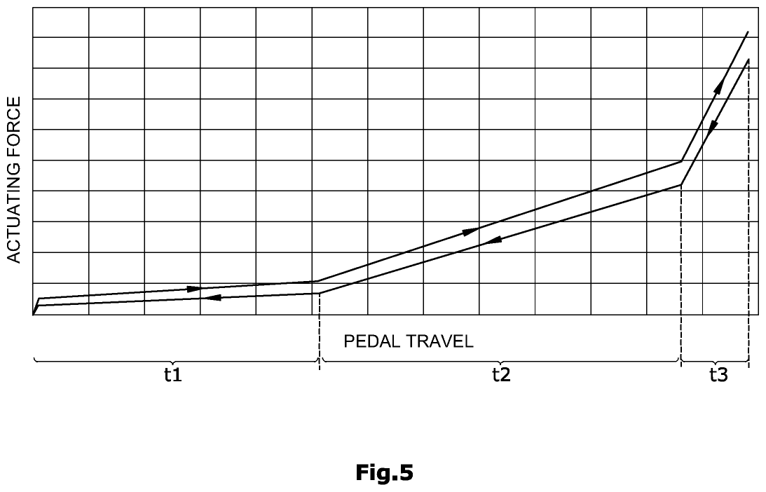

When the pedal lever 20 is actuated by applying the actuating force FB to the pedal lever 20, the pedal lever 20 pivots about the axis of rotation D1 according to the pedal travel/actuating force characteristic shown in FIG. 5. Due to the coupling of the pedal lever 20 to the intermediate lever 30 by the first spring element 42 arranged at the first coupling point KS1, the intermediate lever 30 initially moves together with the pedal lever 20 in a first travel section t1. Due to the fact that the spring rate of the first spring element 42 is higher than that of the second spring element 44, the first spring element 42 is virtually not compressed in the first travel section t1, wherein the second spring element 44 is continuously compressed until the intermediate lever 30 abuts against the housing 12 via a buffer element 32. As the intermediate lever 30 is displaced and the second spring element 44 is compressed, the spring force acting on the intermediate lever 30 from the spring element 44 increases continuously, whereby the load emanating from the intermediate lever 30 and acting on the pedal lever 20 at the third coupling point KS3 increases as a result of a lever action due to the coupling points KS1, KS2, and KS3, which are spaced apart from one another in the longitudinal direction of the intermediate lever 30. This load increases the frictional force acting between the bearing surfaces 24, 26, and the bearing surface 28, and thus increases the friction between the housing 12 and the pedal lever 20 at the bearing point LS. In a second travel section t2, the intermediate lever 30 is not moved, wherein the first spring element 42 is compressed with increasing pedal travel until the pedal lever 20 abuts against the housing 12 via a buffer element 21. The previously caused friction also acts in the second travel section t2. A third travel section t3, shown in FIG. 5, depicts the deformation of the buffer element 21, which is made of an elastomer and deforms when compressed.

In order to increase the frictional force between the bearing surfaces 24, 26, and the mating bearing surface 28, an additional loading unit 50 is provided, which has a loading element 52 mounted in the manner of a rocker on the housing 12 and a spring element 54. One end of the loading element 52 is coupled to the spring element 54, which is formed by the third spring element 46, and a second end is in sliding contact with the intermediate lever 30. The preloaded spring element 54 presses the second end of the loading element 52 against the intermediate lever 30 in such a way that the load acting on the pedal lever 20 from the intermediate lever 30 at the third coupling point KS3 is increased, thereby increasing the frictional force between the bearing surfaces 24, 26 of the housing 12 and the bearing surface 28 of the pedal lever 20. In addition, the angles a1, a2 can be specifically selected to adjust the frictional force between the bearing surfaces 24, 26 and the counter bearing surface 28.

The loading of the pedal lever 20 by the intermediate element 30 and by the additional loading unit 50 causes or increases the frictional force between the bearing surfaces 24, 26 and the counter bearing surface 28, resulting in a pedal travel/actuating force characteristic with hysteresis, which is shown in FIG. 5.

The second embodiment shown in FIG. 2 differs essentially from the first embodiment according to FIG. 1 in that the intermediate lever 30 is mounted in a sliding manner on the housing 12 via the third coupling point KS3, wherein the third spring element 46, which also serves as a fail-safe spring in the second embodiment, presses the intermediate lever 30 against the housing 12. The third spring element 46 is arranged between the pedal lever 20 and the intermediate lever 30. A friction element 60 is provided on a side of the intermediate lever 30 facing the housing 12, via which the intermediate lever 30 bears against the housing 12. In addition, the first spring element 42 and the second spring element 44 are arranged coaxially to one another, which means that no lever action is caused when the pedal lever 20 is actuated.

When the pedal lever 20 is actuated by applying the actuating force FB to the pedal lever 20, the pedal lever 20 pivots about the axis of rotation D1 according to the pedal travel/actuating force diagram shown in FIG. 5. In the process, the spring elements 42, 44 are compressed one after the other, as in the first embodiment shown in FIG. 1, resulting in the force curve with the different travel sections t1, t2 shown in FIG. 5. The decisive difference is that in the first travel section t1, the intermediate lever 30 moves together with the pedal lever 20 and moves relative to the housing 12 in a sliding manner at the third coupling point KS3. The friction between the friction element 60 of the intermediate lever 30 and the housing 12 during the displacement also results in a pedal travel/actuating force characteristic with hysteresis. The third spring element 46 also serves as a fail-safe spring or as the return spring 48.

The third embodiment shown in FIG. 3 represents a combination of the embodiments shown in FIG. 1 and FIG. 2. As in the second embodiment in FIG. 2, the intermediate lever 30 is mounted on the housing 12 in a sliding manner via the third coupling point KS3, wherein the pedal lever 20 bears against the intermediate lever 30 at the first coupling point KS1, and the first and second spring element 42, 44 are arranged at the second coupling point. The coupling points KS1, KS2 are arranged at a distance from one another in the longitudinal direction of the intermediate lever 30 in such a way that when the pedal lever 20 is actuated, a lever action is caused on the intermediate lever 30 such that the load at the third coupling point KS3 increases and a load relevant to the friction present between the housing 12 and the intermediate lever 30 is caused. The third spring element 46, which also serves as a return spring 48, as in the two other embodiments, additionally presses the intermediate lever 30 against the housing 12, thereby causing additional friction between the friction element 60 and the housing 12.

When the pedal lever 20 is actuated by applying the actuating force FB to the pedal lever 20, the pedal lever 20 pivots about the axis of rotation D1. Here, the spring elements 42, 44 are compressed one after the other, as in the two other embodiments shown in FIG. 1 and FIG. 2. This also results in a pedal travel/actuating force characteristic with hysteresis, in that the lever action on the intermediate lever 30 and the load from the third spring element 46 press the intermediate lever 30 with the friction element 60 against the housing 12, thereby causing friction.

### List of Reference Numbers

10 pedal device
12 housing
14 first housing element
16 second housing element
20 pedal lever
21 buffer element
30 intermediate lever
32 buffer element
40 force-generating unit
42 first spring element
44 second spring element
46 third spring element
48 return spring
50 additional loading unit
52 loading element
54 spring element
60 friction element
D1 axis of rotation
FB actuating force
KS1 first coupling point
KS2 second coupling point
KS3 third coupling point
LS bearing point
t1 first travel section
t2 second travel section
t3 third travel section

The above description is that of a current embodiment of the invention. Various alterations and changes can be made without departing from the spirit and broader aspects of the invention. This disclosure is presented for illustrative purposes and should not be interpreted as an exhaustive description of all embodiments of the invention or to limit the scope of the claims to the specific elements illustrated or described in connection with these embodiments. Any reference to elements in the singular, for example, using the articles “a,” “an,” “the,” or “said,” is not to be construed as limiting the element to the singular.

1. A pedal device for a vehicle, comprising:
a housing;
a pedal lever which is pivotally mounted in a sliding bearing at a bearing point on the housing;
an intermediate lever which is coupled to the pedal lever via a first coupling point and to the housing via a second coupling point; and
a force-generating unit for exerting a counterforce on the pivotally mounted pedal lever, the counterforce acting in the opposite direction to an actuating force exerted on the pivotally mounted pedal lever;
wherein the first coupling point and the second coupling point are arranged at a distance from one another in a longitudinal direction of the intermediate lever;
wherein the force-generating unit has a first spring element arranged at the second coupling point;
wherein the intermediate lever one of:
bears against the pedal lever via a third coupling point in a region of the bearing point of the pedal lever such that during actuation of the pedal lever, the intermediate lever acts on the pedal lever via the third coupling point in such a loading manner that a pedal travel/actuating force curve with hysteresis is produced; and
is slidingly mounted on the housing via a third coupling point, such that during actuation of the pedal lever, the intermediate lever acts on the housing via the third coupling point in such a loading manner that a pedal travel/actuating force curve with hysteresis is produced.

2. The pedal device according to claim 1, wherein an additional loading unit is provided, which is arranged in the region of the bearing point, wherein the additional loading unit has a loading element and a second spring element arranged between the housing and the loading element, wherein the loading element resting in a spring-biased manner against the intermediate lever in such a way that the intermediate lever is loaded in a direction of the pedal lever.

3. The pedal device according to claim 2, wherein the loading element is mounted in the manner of a rocker on the housing, wherein the loading element bears with a first end against the intermediate lever in a region of the third coupling point, and the second spring element acts on a second end.

4. A pedal device for a vehicle comprising:
a housing;
a pedal lever which is pivotally mounted at a bearing point on the housing;
an intermediate lever which is coupled to the pedal lever via a first coupling point and to the housing via a second coupling point; and
a force-generating unit for exerting a counterforce on the pivotally mounted pedal lever, the counterforce acting in the opposite direction to an actuating force exerted on the pivotally mounted pedal lever;
wherein the force-generating unit has a first spring element arranged at the second coupling point;
wherein the intermediate lever is loaded via a third coupling point on the housing by a second spring element arranged between the intermediate lever and the pedal lever; and
wherein the intermediate lever is mounted with sliding friction in such a way that the intermediate lever is loaded by the second spring element arranged at the third coupling point in such a way that a pedal travel/actuating force curve with hysteresis is produced.

5. The pedal device according to claim 1, wherein the intermediate lever has a friction element at the third coupling point, via which the intermediate lever bears against the housing.

6. The pedal device according to claim 1, wherein the force-generating unit has a first spring element and a second spring element, wherein the first spring element is arranged at the first coupling point, and the second spring element is arranged at the second coupling point, wherein the second spring element has a lower spring rate than the first spring element, and wherein the intermediate lever strikes against a stop of the housing from a predefined spring travel of the second spring element.

7. The pedal device according to claim 1, wherein the force-generating unit has a first spring element and a second spring element, wherein the first and second spring elements are arranged at the second coupling point and in series, wherein the second spring element has a lower spring rate than the first spring element, and wherein the intermediate lever strikes against a stop of the housing from a predefined spring travel of the second spring element.

8. The pedal device according to claim 1, wherein the stop between the intermediate lever and the housing is arranged at a distance from the first coupling point in a longitudinal direction of the intermediate lever.

9. The pedal device according to claim 6, wherein the first spring element and the second spring element are arranged coaxially to one another.

10. The pedal device according to claim 6, wherein the pedal lever has a cylindrical bearing surface at the bearing point, via which the pedal lever bears locally against a plurality of bearing surfaces of the housing, which are spaced apart from one another in a circumferential direction, with a predefined slope.

11. The pedal device according to claim 1, wherein the force-generating unit has a return spring, via which the pedal lever is loaded in a direction of a rest position.

12. The pedal device according to claim 11, wherein a second spring element of an additional loading unit is the return spring.

13. The pedal device according to claim 11, wherein a third spring element arranged at the third coupling point is the return spring.

14. An automobile having the pedal device of claim 1.
